(19) United States
(12) Patent Application Publication
(10) Pub. No.: US 2009/0322526 A1
(43) Pub. Date: Dec. 31, 2009

(54) ARRANGEMENT AND METHOD FOR COMMUNICATING WITH NOTIFICATION APPLIANCES

(76) Inventor: Karen D. Lontka, Randolph, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/492,061

(22) Filed: Jun. 25, 2009

Related U.S. Application Data
(60) Provisional application No. 61/075,430, filed on Jun. 25, 2008.

(51) Int. Cl. G08B 21/00

(52) U.S. Cl. 340/540

(57) ABSTRACT

An emergency notification arrangement includes a control unit, feed and return conductors, and a plurality of notification units. The control unit includes a controller, a modulator, and a bias power source. The controller is configured to generate modulation signals having a data frame format. The modulator is configured to modulate the modulation signals onto a bias power voltage generated by the bias power source. The feed conductor is operably coupled to receive the bias power voltage modulated by the modulation signals. A first notification unit includes a demodulator, a controller, a driver circuit and a signaling unit configured to provide an audible and/or visible notification under the control of a drive signal, wherein the demodulator is configured to provide a received signal representative of the modulation signals to the controller, wherein the controller is configured to cooperate with the driver circuit to cause the signaling unit to operate in a predetermined manner based on the received modulation signals.

This application claims the benefit of U.S. Provisional Patent Application Ser. No. 61/075,430, filed Jun. 25, 2008, which is incorporated herein by reference.

### FIELD OF THE INVENTION

The present invention relates to circuits in building systems that provide signals to devices distributed at different areas of a building or facility.

### BACKGROUND

Fire safety systems include, among other things, detection devices and notification devices. Detection devices include smoke, heat or gas detectors that identify a potentially unsafe condition in a building or other facility. Detection devices can also include manually operated pull stations. Notification devices, often referred to as notification appliances, include horns, strobes, and other devices that provide an audible and/or visible notification of an unsafe condition, such as a “fire alarm”.

In its simplest form, a fire safety system may be a residential “smoke alarm” that detects the presence of smoke and provides an audible alarm responsive to the detection of smoke. Such a smoke alarm device serves as both a detection device and a notification appliance.

In commercial, industrial, and multiple-unit residential buildings, fire safety systems are more sophisticated. In general, a commercial fire safety system will include one or more fire control panels that serve as distributed control elements. Each fire control panel may be connected to a plurality of distributed detection devices and/or a plurality of distributed notification appliances. The fire control panel serves as a focal point for problem-indicating signals that are generated by the distributed detection devices, as well as a source of activation (i.e. notification) signals for the distributed notification appliances. Most fire safety systems in larger buildings include multiple fire control panels connected by a data network. The fire control panels employ this network to distribute information regarding alarms and maintenance amongst each other. In such a way, notification of a fire or other emergency may be propagated throughout a large facility.

Building safety codes define the specifications for notification appliance wiring, voltage and current. For example, according to building safety codes, notification appliances are intended to operate from a nominal 24 volt signal which provides the power for the notification appliance to perform its notification function. For example, an alarm bell, a strobe light, or an electronic audible alarm device operates from a nominal 24 volt supply. In general, however, notification devices are required to operate at voltages as low as 16 volts. The delivery of power to the distributed notification appliances requires a significant amount of wiring and/or a significant number of distributed power sources.

In particular, notification appliances are typically connected in parallel in what is known as a notification appliance circuit or NAC. Each NAC is connected to a power source, such as a 24 volt source, and includes a positive (Feed) conductor, a ground (Return) conductor, and multiple notification appliances connected across the two conductors. The power source is typically disposed in a fire control panel or other panel. The feed and return NAC conductors serve to deliver the operating voltage from the 24 volt power source, to the distributed notification appliances.

Traditionally, an NAC uses simple power interruption (pulse and/or pulse width) to control the synchronization of horns and strobes in the notification appliances. In other words, the 24 signal is interrupted to provide a sort of signaling on the power distribution wiring. However, this level of control is limited. There is a need for a more versatile communication scheme in an NAC, but preferably one that does not increase the cost associated with wiring NACs.

### SUMMARY OF THE INVENTION

The above described needs, as well as others, are addressed by at least some embodiments of an NAC that employs structured data communications modulated onto the bias power voltage that is distributed via the feed and return conductors.

In a first embodiment, an emergency notification arrangement includes a control unit, feed and return conductors, and a plurality of notification units. The control unit includes a controller, a modulator, and a bias power source. The controller is configured to generate modulation signals having a data frame format. The modulator is configured to modulate the modulation signals onto a bias power voltage generated by the bias power source. The feed conductor is operably coupled to receive the bias power voltage modulated by the modulation signals. A first notification unit includes a demodulator, a controller, a driver circuit and a signaling unit configured to provide an audible and/or visible notification under the control of a drive signal, wherein the demodulator is configured to provide a received signal representative of the modulation signals to the controller, wherein the controller is configured to cooperate with the driver circuit to cause the signaling unit to operate in a predetermined manner based on the received modulation signals.

The above describe features and advantages, as well as others, will become more readily apparent to those of ordinary skill in the art by reference to the following detailed description and accompanying drawings.

### BRIEF DESCRIPTION OF THE DRAWINGS

FIG. 1 shows a schematic block diagram of an exemplary NAC according to a first embodiment of the invention that may form a part of a fire safety system;

FIG. 2 shows a schematic block diagram of a notification appliance device that may be used in the NAC of FIG. 1;

FIG. 3 shows a diagram of an exemplary data frame that may be used to carry out communications in an NAC in accordance with an embodiment of the invention;

FIG. 4 shows an exemplary timing diagram of data signals communicated to a notification appliance and control signals generated by a notification appliance in accordance with an embodiment of the invention;

FIG. 5 shows a timing diagrams illustrating an exemplary modulation method that may be used to transmit data signals in embodiments of the invention;

FIG. 6 shows a first exemplary modulation arrangement that may be used to modulate signals in accordance with embodiments of the invention; and

FIG. 7 shows a second exemplary modulation arrangement that may be used to modulate signals in accordance with embodiments of the invention.

### DETAILED DESCRIPTION

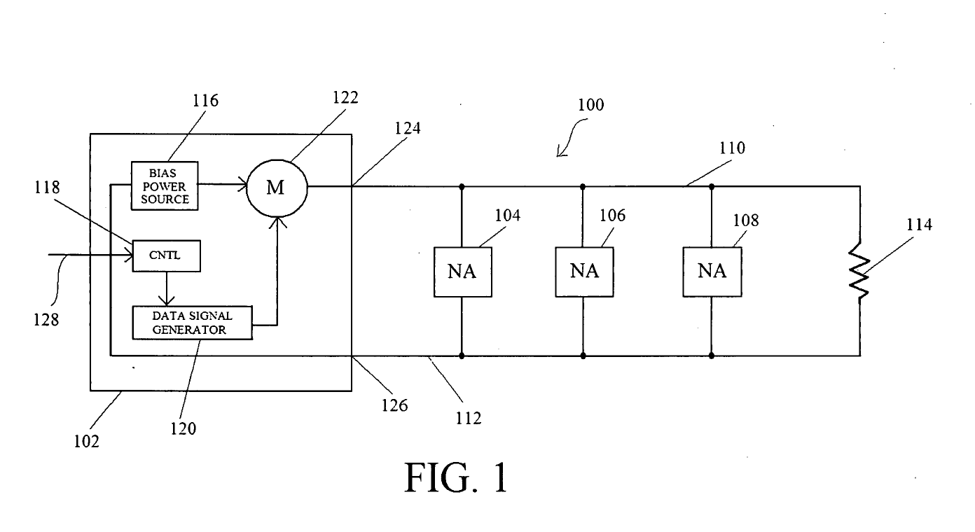

FIG. 1 shows a schematic block diagram of an exemplary NAC 100 according to a first embodiment of the invention that may form a part of a fire safety system. The NAC includes a control panel 102, a plurality of notification appliances 104, 106 and 108, a first (feed) conductor 110, a second (return) conductor 112, and an end of line resistor 114. In general, the NAC 100 may include many more notification appliances. Moreover, the NAC 100 is suitable for use in a fire control system that can include many other NACs, as well as detector or sensor circuits, as is known in the art.

The control panel 102 is a housed unit that includes a bias power source 116, a controller 118, a data signal generator 120, and a modulator 122. The control panel 102 further includes a feed conductor output 124, a return conductor output 126, and a signaling input 128.

The bias power source 116 is a circuit configured to generate a bias voltage and provide the bias voltage to the modulator 122. The bias voltage is referenced to a return path which is coupled to the return conductor output 126. The bias voltage is a DC signal having a voltage suitable for operating notification appliances in a fire control network. In the exemplary embodiment described herein, the bias power source 116 is configured to generate a bias voltage of 24 to 26 volts DC. The bias power source 116 may suitably generate the bias voltage from mains electrical service, an external DC bus or self-contained means such as batteries or the like. In exemplary embodiments, the bias power source 116 generates the bias voltage from the 120 volt AC signal in the mains electrical service using a filtered bridge circuit, or a switching power supply. Such circuits are known.

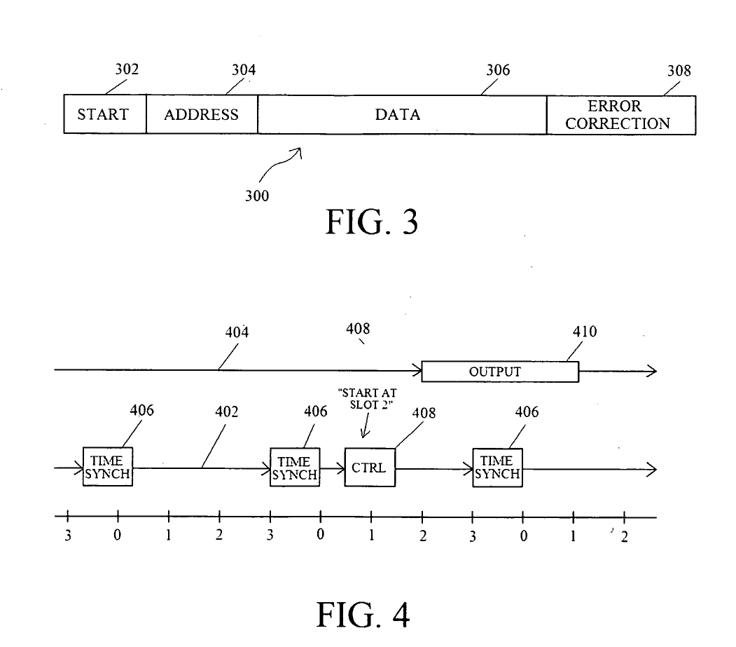

The controller 118 is a processor device, and its support circuitry, that are configured to control the overall operation of the NAC. To this end, the controller 118 originates data messages that are to be communicated to the notification appliances 104, 106 and 108 to control and synchronize the operation of such devices. As will be discussed below, the controller 118 is configured to generate data for data frames having the format shown in FIG. 3 and provide such data to the data signal generator 120. The controller 118 is operably coupled to the signaling input 128 to receive externally generated signals, such as, for example, signals indicating that one or more notification appliances should be activated. The controller 118 may also be configured to cooperate with other circuitry, not shown, to apply test signals to the feed and return conductors 110, 112 to test the NAC for continuity. Such other circuitry, which performs continuity testing in conjunction with the end-of-line resistor 114, may take multiple forms and is known in the art.

The data signal generator 120 is a circuit that is configured to generate modulation signals containing the data frame data received from the controller 118. The modulation signals may take the form of phase shift key (PSK) modulation signals, or frequency shift key (FSK) modulation signals. To this end, the data signal generator 120 preferably includes a source of a relatively precise (but relatively low) frequency carrier signal, as well as circuitry for phase shift keying or frequency shift keying the carrier signal to modulate the data generated by the controller 118 onto the carrier signal. Such circuits are known.

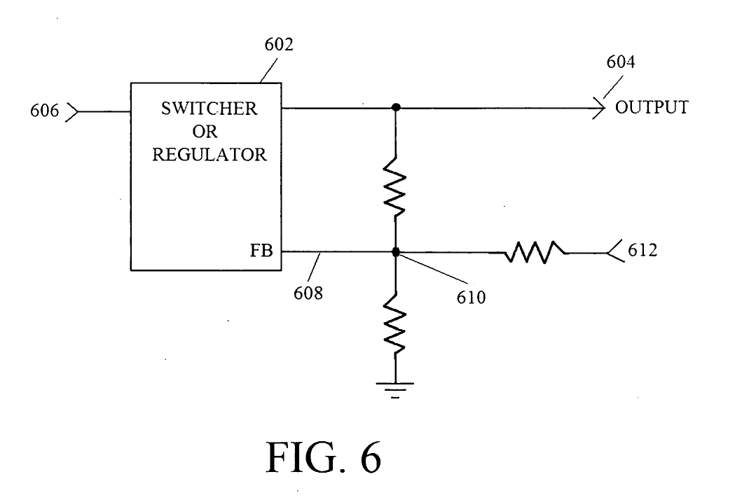

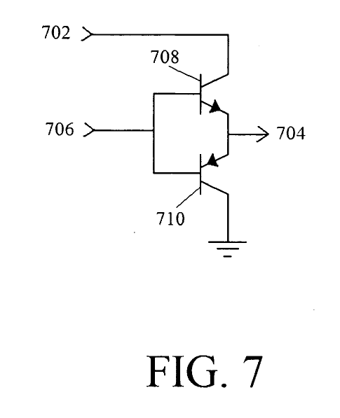

The modulator 122 is a circuit arrangement configured to add, modulate and/or superimpose the modulation signals onto the bias voltage generated by the bias voltage source. Examples of modulation schemes that include embodiments of the modulator 122 are shown in FIGS. 6 and 7, discussed further below. The output of the modulator 122 is coupled to the feed conductor output 124.

The feed conductor 110 couples the feed conductor output 124 to feed inputs of each of the notification appliances 104, 106 and 108. The return conductor 112 couples the return conductor output 126 to return inputs of each of the notification appliances 104, 106 and 108. The notification appliances 104, 106 and 108 are typically distributed throughout a building or portion of a building, not shown. The notification appliances 104, 106 and 108 are configured to provide distributed audible or visible notification to occupants of the building.

Because the notification appliances 104, 106 and 108 are distributed in different areas of the building, the feed conductor 110 and return conductor 112 may have significant length. The end-of-line resistor 114 is coupled between the feed conductor 110 and the return conductor 112 downstream of the most downstream notification appliance 108. The end-of-line resistor 114 is employed in methods known in the art to test for continuity of the conductors 110, 112. In other known NAC configurations, the feed conductor 110 and the return conductor 112 both loop back to the control unit 102, thereby providing redundancy in the case of a break. In such configurations, the end-of-line resistor 114 may suitably be located within the control unit 102.

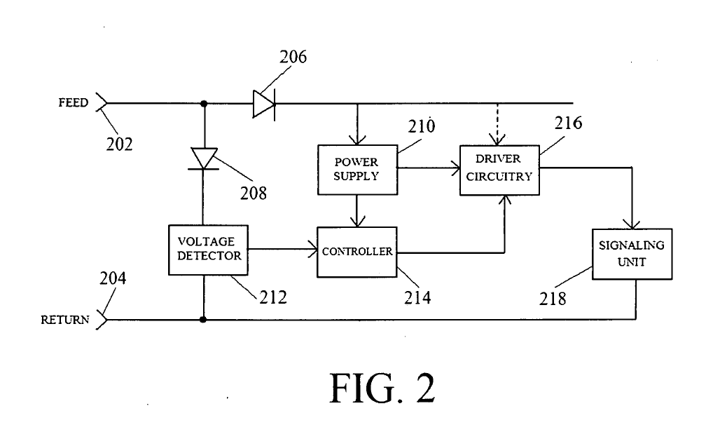

FIG. 2 shows an exemplary embodiment of a notification appliance 200 that may be employed as the notification appliance 104, 106 and/or 108 of FIG. 1. The notification appliance 200 includes a feed input 202, a return input 204, first and second blocking diodes 206, 208, a power supply 210, a voltage detector 212, a controller 214, a driver circuit 216, and a signaling unit 218. In general, the notification appliance 200 may be a device that generates an audible alarm, such as a horn, or a visible alarm, such as a strobe.

The feed input 202 is configured to be connected to a feed conductor of an NAC, and the return input 204 is configured to be connected to return conductor of an NAC. The voltage detector 212 is a device that is capable of detecting a modulated signal as generated by the data signal generator 120 of FIG. 1. The voltage detector 212 is further capable of providing a recovered version of the modulated signal to the controller 214. An exemplary embodiment of the voltage detector 212 may include an operational amplifier, not shown, with a positive input connected to the diode 208 via a resistive voltage divider, not shown, and a negative input connected to the operational amplifier output. The operational amplifier output further connected to the controller 214.

The controller 214 is a circuit that is configured to receive the modulated signal obtained by the voltage detector 212, and to obtain the data transmitted within the signal. To this end, the controller 214 may include a circuit or device that demodulates PSK or FSK signals, as necessary, and devices that further perform error checking and correction. The controller 214 furthermore is configured to determine whether a data signal is addressed to the appliance 200, and to determine the content of command data or other operational information in the data signal.

The controller 214 is still further configured to generate control signals that are provided to the driver circuit 216. The controller 214 generates the control signals responsive to data signals received via the voltage detector 212.

The power supply 210 is a circuit that is configured to convert the bias voltage received via the feed input 202 to voltages required by the various circuits in the appliance 200, such as the controller 214 and in some cases the driver circuit 216. Suitable power supplies are known and can, for example, take the form of a switching power supply or a linear power supply.

The signaling unit 218 is a device that generates an audible or visible signal responsive to power signals received from the driver circuit 216. The signaling unit 218 may suitably be a horn or strobe device, among other things. The driver circuit 216 is a circuit that provides power to the signaling unit 218 in a controlled manner that corresponds to control signals generated by the controller 214. To this end, the driver circuit 216 may include a power MOSFET switch, a current controller or other power circuit. Suitable combinations of signaling units and corresponding driver circuits are known and may be employed by those of ordinary skill in the art.

In the operation of the devices of FIGS. 1 and 2, the controller 118 provides data signals to one or more of the notification appliances 104, 106 and 108. Such data signals can include time synchronization signals that ensure that the appliances 104, 106 and 108 have synchronized clocks, and/or include signals that cause or control operation of the signaling units (e.g. signaling unit 218) within the appliances 104, 106, 108.

To this end, the controller 118 generates data generally corresponding to the data format 300 shown in FIG. 3. The data format 300 defines a data frame having a start code field 302, an address field 304, a data field 306, and an error check and correction (ECC) field 308. The start code field 302 provides an indication to the receiving appliances that a data frame is starting. To improve detection, the start code field 302 may be defined such that it employs data corresponding to f/2 signals for FSK signals, or minus phase shift for PSK signals. Such signals are not ordinary data bits in such signals, thus providing a good “start” indication. Thus, the start code field 302 may in some cases be completely generated by the data signal generator 120 instead of the controller 118.

The address field 304 identifies the address of the appliance 104, 106 or 108 to which the data signal is to be sent. Data signals may be addressed to individual appliances 104, 106 or 108, predefined “groups” of appliances, or to “all” appliances.

The data field 306 contains the actual information for the appliance(s) to which the data signal is addressed. The data field 306 may suitably include on/off controls, parameter controls, synchronization signals, or other information. Table I shows a set of possible data field commands.

TABLE I

| Command | Purpose |
|---|---|
| Time sync. | Used to keep the internal clocks in all of the appliances |
| | in step. |
| Horn Control. | Turn on/off all receiving devices that respond as a |
| | horn signal |
| Strobe Control. | Turn on/off all receiving devices that respond to a |
| | strobe signal |
| Set Intensity. | A global or selective command that can change the level |
| | of the signal (louder/softer or brighter/dimmer, etc.) |

The ECC field 308 may be used for error checking and correction, and may employ CRC code/data, a parity bit or bits, or other known ECC scheme. The generation of such fields is known.

The data signal generator 120 then generates the actual PSK-modulated, FSK-modulated or other modulated signal that is to be superimposed onto (i.e. modulated onto or added to) the bias voltage generated by the bias power source 116. The data signal generator 120 employs known techniques to convert the data received from the controller 118 into a series of PSK or FSK bits in the form of the data frame 300 of FIG. 3. As discussed above, however, the start code can be a unique signal that is not an ordinary bit value in the chosen modulation scheme.

FIG. 5 shows a timing diagram of an exemplary FSK modulation signal that could be generated by the data signal generator 120 of FIG. 1. The exemplary FSK modulation signal illustrates a sequence “start”, “0”, “1”, “0”, “1”. The data signal generator 120 in this case has generated a special f/2 signal as the start code, which helps the receiving device to recognize the beginning of a frame. The bits 0, 1, 0, 1 may suitable be all or part of the address field. The data field and ECC field would follow.

Referring again to FIG. 1, the data signal generator 120 formulates the modulation signal by converting the address information, data information, and ECC information provided by the controller 118 into the FSK (or PSK) stream conforming to the format 300 of FIG. 3. It will be appreciated that the data signal generator 120 may provide some of the functions ascribed to the controller 118 and/or vice versa to carry out the generation of the modulation signal.

In any event, the data signal generator 120 provides the modulation signal to the modulator 122. The modulation signal now has the form of the data frame 300 of FIG. 3. The modulator 122 superimposes the modulation signal onto the bias voltage. The bias voltage, which may suitably be approximately 24 volts DC, is provided to the modulator 122 by the bias power source 116.

The modulation signal has a relatively small amplitude compared to the bias voltage, and thus does not adversely affect the power delivery aspect of the bias voltage. The peak-to-peak variation of the modulation signal is preferably at least in the range of an order of magnitude less than 24 volts.

The modulated bias voltage signal (containing the data frame) then propagates down the feed conductor 110 to the notification appliances (NAs) 104, 106 and 108. For the purposes of this discussion, it will be assumed that the NA 200 of FIG. 2 is the NA 104 of FIG. 1. Referring to FIG. 2, the modulated bias voltage signal is provided to the power supply 210 and the voltage detector 212. Because the bias voltage signal is well above the turn-on voltage of the diodes 206, and 208, the modulated signal fully passes to the voltage detector 212 and the power supply 210. The power supply 210 does not, however, process the data signal portion of the modulated bias voltage signal, but rather employs the voltage to generate the bias voltages for the circuits within the NA 200.

The voltage detector 212, however, detects the modulated data signal and provides the data signal to the controller 214. The controller 214 converts the modulated (i.e. FSK or PSK) signal to extract the fields of the data frame. The controller 214 performs any error correction using the ECC information in the ECC field 308. The controller 214 further determines whether the data signal is intended for the NA 104/200 using information in the address field 304. If the data signal is not addressed to the NA 104/200, to all NAs 104, 106 108, or to a predefined group of which the NA 104/200 is a part, then the controller 214 ignores the message. However, if the data signal is addressed directly or indirectly to the NA 104/200, then the controller 214 obtains the information and/or command from the data field 306 of the message.

The controller 214 then provides appropriate control signals to the driver circuit 216 that cause the driver circuit 216 to operate the signaling circuit in a manner that is consistent with the command obtained from the field 306 of the data signal. For example, the controller 214 may provide a signal that closes a power MOSFET, not shown, in the driver circuit 216, which causes power to be provided to a horn (unit 218). In another example, the controller 214 may provide a sequence of signals to a power MOSFET of the driver circuit 216 that cause a strobe (unit 218) to flash in a synchronized fashion.

An issue that arises with addressing devices in an NAC such as the NAC 100 is ensuring synchronization of the notification appliances. It is typically a requirement that signaling units such as strobes and horns operate substantially in a synchronized manner.

To address this issue, the controller 118 can issue periodic synchronization signals in modulated data signals generated in the manner described above. The controllers at the NAs (e.g. the controller 214 at NA 104/200) then use this signal to synchronize their internal clocks/time slot sequence. This synchronization, in this embodiment, causes each of the NAs 104, 106 and 108 to have aligned time slots.

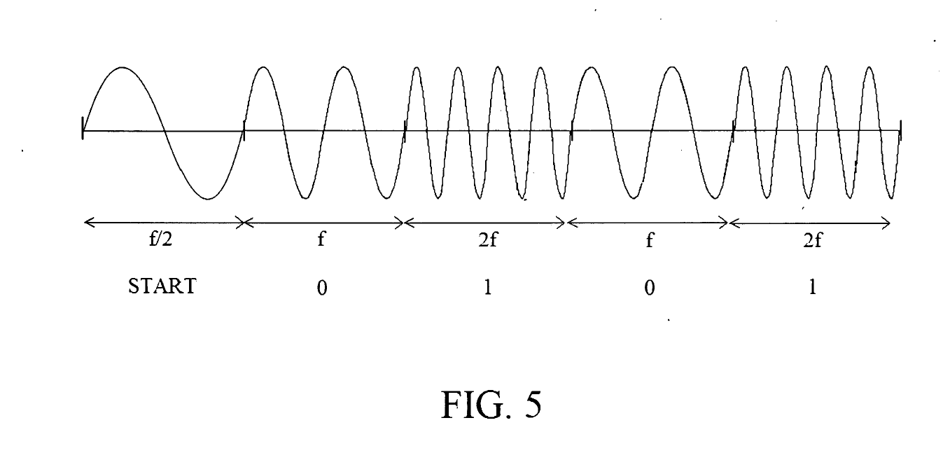

For example, FIG. 4 shows a timing diagram of a data signal sequence 402 received by the controller 214 of the NA 200 of FIG. 2, and the control signal output sequence 404 of the controller 214. The data signal sequence 402 includes periodically received synchronization signals 406 and a control signal 408. Each of the signals 406 and 408 has the general structure of the data frame 300 of FIG. 3.

The controller 214 aligns its “0” time slots up with the received synchronization signals 406. In normal operation, all of the other NAs 104, 106 and 108 behave in a similar manner such that all NAs 104, 106 and 108 have their time slots aligned.

In the event of a fire alarm condition, for example, the controller 214 also receives the control signal 408. The control signal 408 in this example provides a command to provide a signaling output (e.g. audible or visible signal) beginning at time slot “2”. In this example, all of the NAs 104, 106 and 108 receive the same control signal 408. At time slot “2”, the controller 214 generates the output signal 410 that cause the driver circuit 216 to operate the signaling unit 218. Because all NAs 104, 106 and 108 generate the output at their respective time slot “2”, and because the time slot “2” of all NAs 104, 106 and 108 have been synchronized, the outputs of the NAs 104, 106 and 108 are all synchronized.

It will be appreciated that the NA 200 may take various forms, including those in which the driver circuit 216 is directly powered by the bias voltage received at the feed input 202. In some embodiments, the driver circuit 216 may be able to vary aspect of the signaling output, such as volume, pattern, or intensity, all per control signals generated by the controller 214. In addition, it will be appreciated that the modulation, control and signal generating circuitry of the control unit 102 may take any suitable form known in the art to carry out the operations described above.

FIGS. 6 and 7 show different embodiments of the modulator 122 of FIG. 1 suitable for different types of known bias voltage generators 116 of fire control panels. FIG. 6 shows a bias voltage generator 116 in the form of a switching power supply or regulator 602 that employs feedback control via an output feedback line 608. The input 606 is configured to be coupled to a source of raw power, such as the mains electrical system. The switching power supply 602 generates a regulated 24-26 volt output at the output 604, which is modulated by a modulation signal provided at the modulation input 612. The modulation signal 612 is superimposed at the feedback node 608/610. The node 608 is coupled to the input 612 by a resistor, to the output 604 by another resistor, and to ground by yet another resistor. The output 604 provides a 24-26 volt signal superimposed with the modulation signal received at the input 612.

FIG. 7 shows a different embodiment in which raw power is provided to an input 702. Two transistors 708, 710 have output terminals coupled in series between the input 702 and ground. More specifically, the first transistor 708 is an NPN BJT have a collector coupled to the input 702 and an emitter coupled to the output 704. The second transistor 710 is a PNP BJT having an emitter coupled to the output 704 and a collector coupled to ground. A control input 706 is coupled to the base of each transistor 708, 710. The control signal provided at the control input 706 provides the information which both regulates the output 704 at approximately 24 volts DC, and includes the modulation to transmit the data signal. The output 704 produces a 24 volt signal modulated by the modulation signal.

It will be appreciated that the above-described embodiments are merely exemplary, and that those of ordinary skill in the art may readily devise their own implementations and modifications that incorporate the principles of the present invention and fall within the spirit and scope thereof.

I claim:

1. An emergency notification arrangement, comprising:
a) a control unit comprising a controller, a modulator, and a bias power source; the controller configured to generate modulation signals having a data frame format, the modulator configured to modulate the modulation signals to a bias power voltage generated by the bias power source;
b) feed and return conductors, the feed conductor operably coupled to receive the bias power voltage modulated by the modulation signals; and
c) a plurality of notification units, at least a first notification unit including a demodulator, a controller, a driver circuit and a signaling unit configured to provide an audible and/or visible notification under the control of a drive signal, wherein the demodulator is configured to provide a received signal representative of the modulation signals to the controller, wherein the controller is configured to cooperate with the driver circuit to cause the signaling unit to operate in a predetermined manner based on the received modulation signals.

2. The arrangement of claim 1, wherein the controller of the first notification unit is configured to adjust an internal clock based on at least a first of the received modulation signals.

3. The arrangement of claim 2, wherein at least a second of the received modulation signals includes an operational command for the first notification unit.

4. The arrangement of claim 2, wherein the second of the received modulation signals includes timing information associated with the operational command.
